(19) United States
(12) Patent Application Publication
(10) Pub. No.: US 2009/0016813 A1
(43) Pub. Date: Jan. 15, 2009

(54) Chemically anchorable fastening element

(76) Inventors: Rosa Maria Gonzalez, Feldkirch (AT); Nikolaus Hannoschoeck, Grabs (CH); Bernhard Sander, Munich (DE)

Correspondence Address: ABELMAN, FRAYNE & SCHWAB, 666 THIRD AVENUE, 10TH FLOOR, NEW YORK, NY, 10017, US

(21) Appl. No.: 12/215,335

(22) Filed: Jun. 25, 2008

(30) Foreign Application Priority Data
Jun. 29, 2007 (DE) 10 2007 000 360.0

(51) Int. Cl. F16B 13/00; F16B 13/14

(52) U.S. Cl. 403/267; 403/296

(57) ABSTRACT

A chemically anchorable fastening element (6), includes a holding section (16; 56) for contacting a wall of a borehole (6) and provided with a thread-tapping outer thread (19) and with a load application element (18; 58), a connection section (26; 66) adjoining the holding section (16; 56) and having a smaller radial dimensions than the holding section (16; 56), and an anchoring section (36; 76) adjoining the connection section (26; 66) and likewise having smaller radial dimensions than the holding section (16; 56).

### BACKGROUND OF THE INVENTION

1. Field of the Invention

The present invention relates to a fastening element for being chemically anchored in a borehole and including a holding section for contacting a wall of the borehole and provided with load application means, a connection section adjoining the holding section and having a smaller radial dimensions than the holding section, and an anchoring section adjoining the connection section and likewise having smaller radial dimensions than the holding section.

2. Description of the Prior Art

In order to chemically anchor a fastening element such as, e.g., an anchor rod, a threaded rod, a threaded anchor, or a reinforcement iron, a borehole is formed in an anchorage base, is then filled with a hardenable mass, e.g., a two-component mortar mass, and a fastening element is set in the borehole. After filling the borehole with the hardenable mass, the hardenable mass hardens ensuring that the fastening element has a high load-carrying value. The fastening element can be loaded after a complete hardening of the hardenable mass.

Mechanically anchorable fastening elements such as, e.g., an expansion dowel, can be loaded immediately after being set. However, because of expansion forces that occur in the anchorage base, such fastening elements should be arranged in a constructional component with correspondingly large edge and axis distances.

European Publication EP 0 763 665 A1 discloses a fastening element including a holding section for contacting a wall of the borehole and provided with load application means, a connection section adjoining the holding section and having a smaller radial dimensions than the holding section, and an anchoring section adjoining the connection section and likewise having smaller radial dimensions than the holding section. The borehole for the fastening element is filled with a hardenable mass, and the fastening element is driven into the borehole, with the holding section being clampingly retained in the borehole until a complete hardening of the hardenable mass.

The drawback of the fastening element of the European publication consists in that because of clamping of the holding section in the borehole mouth region, expansion forces are introduced into the constructional component and, as a result, with this fastening element, large edge and axis distances also should be taken into consideration when setting the fastening elements.

An object of the present invention is a chemically anchorable fastening element that can be loaded immediately after being set.

Another object of the present invention is a chemically anchorable fastening element that requires small edge and axis distances when a number of fastening elements is set in a constructional component.

### SUMMARY OF THE INVENTION

These and other objects of the present invention, which will become apparent hereinafter, are achieved by providing a thread-tapping outer thread on the holding section of the fastening element described above.

When an inventive fastening element is driven in a constructional component, the thread-tapping outer thread cuts into the borehole wall and provides a mechanical anchoring of the fastening element in the region of the holding section by forming a helical undercut in the borehole wall. This mechanical anchoring is mostly free from expansion pressures, which makes possible installation of the fastening elements with small edge and axis distances. The inventive fastening element can be loaded immediately after being set. After the hardenable mass is completely loaded, the fastening element has a maximum load level.

Advantageously, the load application means is formed as a thread connection for a to-be-attached object. It is particularly advantageous when the load application means is formed as an inner thread, so that the fastening element can be set flush with the upper surface of the constructional component.

Advantageously, the connection section has a circular cross-section and a diameter that corresponds to about from 0.3 to 0.9 of the outer diameter of the holding section. The axial length of the connection section is so selected that drillings and the drilling dust, which are produced during driving of the fastening element into the borehole and which otherwise can be present in the borehole, can be received in the intermediate space between the outer side of the connection section and the borehole wall.

Advantageously, the anchoring section likewise has a circular cross-section and a diameter that maximum corresponds to the nominal diameter of a borehole the fastening element is to-be-driven in and, thus, is smaller than the outer diameter of the holding section. The axial length of the anchoring section preferably corresponds at least to a half of the smallest radial dimension, e.g., of the diameter of the anchoring section. Advantageously, the outer surface of the anchoring section has a shaped profile, e.g., a thread, knurling, etc., which increases bonding between the hardenable mass an the fastening element in the region of the anchoring section.

The hardenable mass, which is brought after setting of the fastening element warps up immediately the fastening element, which can be loaded to a certain level, in the region of the anchoring and connection sections, with the drillings becoming deposited in the hardenable mass in the region of the connection section.

Advantageously, the lead of the thread-tapping outer thread with respect to the longitudinal axis of the fastening element corresponds to from 30° to 70°. Particularly advantageously, the lead of the thread-tapping outer thread with respect to the longitudinal axis of the fastening element amounts to from about 35° to about 40°. Because the thread-tapping outer thread is formed as a steep thread, only a small impact energy is required for driving the fastening element in a construction.

Advantageously, a flank of the thread-tapping outer thread adjacent to a free end of the holding section has a flank angle toward a plane extending perpendicular to a longitudinal axis of the fastening element corresponding to from 82° to 88°. Advantageously, the flank angle of the rear flank corresponds to about from 84° to 86°. The flat rear flanks provide for self-locking of the fastening element that has been driven in a borehole and prevent automatic loosening of the mechanical anchoring.

Advantageously, a flank of the thread-tapping outer thread remote from a free end of the holding section has a flank angle toward a plane extending perpendicular to a longitudinal axis of the fastening element corresponding to from 3° to 10°. Advantageously, this flank angle of the front flank corresponds to from 4° to 7°. The steeper front flanks advantageously insure the tapping capability of the thread-tapping thread.

Advantageously, the thread-tapping outer thread is formed as a multi-start thread. This insures a simple and correct setting of the fastening element. Advantageously the holding section is provided with at least one channel for the hardenable mass through which the hardenable mass raises up to the free end of the holding section to reliably show the user that the borehole has been completely filled. Further, the up-channel prevents to a most possible extent air inclusions in the hardenable mass and which can adversely affect the carrying capability of the set fastening element. Further, advantageously, the up-channel is formed as a groove formed as a depression on the outer surface of the holding section. In an alternative embodiment, the channel extends in the interior of the holding section and opens at the free end of the holding section.

Advantageously, the fastening element has a filling bore extending substantially along a longitudinal axis of the fastening element proceeding from the holding section and at least into the connection section for filling the borehole with a hardenable mass. The filling bore extends up to the outer side of the fastening element, so that upon filling the filling bore, the hardenable mass can exit into the intermediate space between the fastening element and the borehole wall. Advantageously, the filling bore extends parallel to the longitudinal axis of the fastening element. Advantageously, the filling bore extends into the anchoring section, which insures filling of the borehole at the deepest point of the borehole, providing for a complete filling of the borehole.

Advantageously, the holding section has coupling means and the connection section has complementary counter-coupling means. A so-formed two-part fastening element can be simply and economically produced. According to an alternative embodiment, the connection section and the anchoring section can also be formed as separate parts connectable with each other. Differently, formed separate pats can be assembled with each other in accordance, e.g., with local conditions and with particular requirements to form a fastening element that can advantageously meet particular requirements thereto.

Advantageously, the coupling means has a section with an inner thread, and the counter-coupling means has a section with an outer thread that cooperates with the inner thread section, which permits the two parts to be screwed with each other.

The method of setting a chemically anchorable fastening element according to the present invention includes as a first step, drilling a borehole in a constructional component in which the fastening element should be anchored. After the drilling step, the borehole is cleaned with suitable cleaning means.

Finally, the fastening element is advantageously impact-driven into the borehole with the holding section of the fastening element forming a helically-shaped undercut in a borehole wall for mechanically anchoring the fastening element in the borehole.

A drill for forming the borehole can be provided, in order to form a setting tool for the fastening element, in addition to a drilling tip, with radially outwardly projecting edges that are capable to transmit axial blows from a setting power tool to the fastening element. Then, the borehole is filled with the hardenable mass, with the raised, from the outside visible, hardenable mass indicating a complete filling of the borehole to the user. If the fastening element has a filling bore, the filling of the borehole is advantageously carried out through the filling bore.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a first embodiment of a fastening element according to the present invention;

FIG. 2 a detailed view of a screw thread portion, designated II in FIG. 1, of the outer thread of the holding section of a fastening element according to the present invention;

FIG. 3 a side, partially cross-sectional view of a second embodiment of a fastening element according to the present invention;

FIG. 4a a cross-sectional view illustrating initial steps of the inventive method of setting a fastening element; and

FIG. 4b a cross-sectional view illustrating the final step of the inventive method of setting a fastening element.

### DETAILED DESCRIPTION OF THE PREFERRED EMBODIMENTS

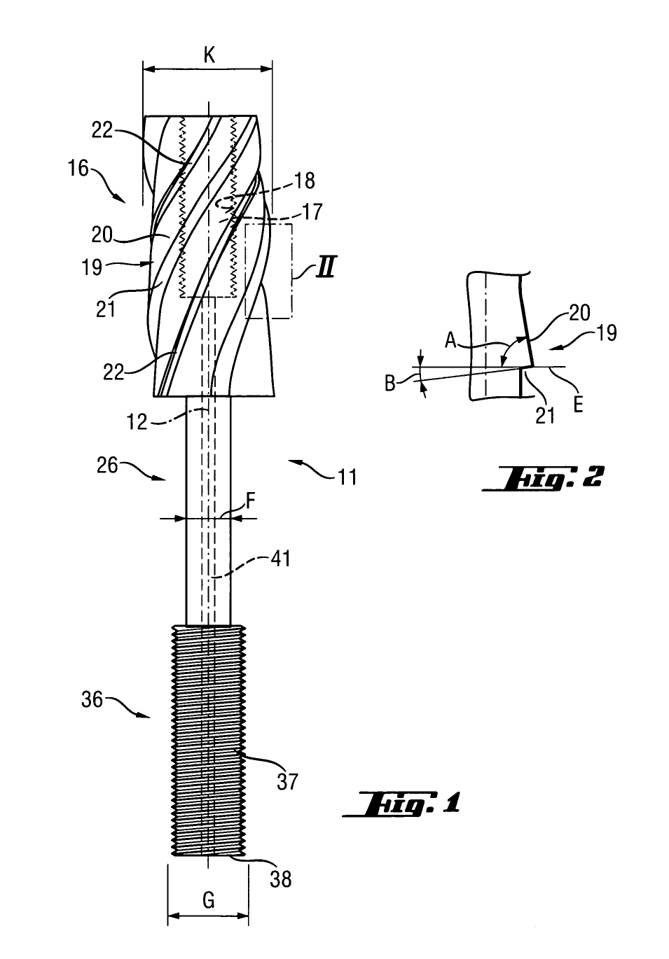

A chemically anchorable fastening element 11 according to the present invention, a first embodiment of which is shown in FIGS. 1-2, extends along a longitudinal axis 12 and has a holding section 16 for contacting the wall of a borehole, a connection section 26 that adjoins the holding section 16, and an anchoring section 36 that adjoins the connection section.

The holding section 16 has a blind bore 17 provided with an inner thread that functions as load application means. On the outer side of the holding section 16, there is provided a multi-start thread-tapping outer thread 19 the lead of which with respect to the longitudinal axis 12 corresponds to 35°. The flank angle A toward a plane E, which extends perpendicular to the longitudinal axes 12 of the fastening element 11, of a flank 20 adjacent to the free end of the holding section of the outer thread 19 corresponds to 85°. The flank angle B toward the plane E of a flank 21 of the outer thread 19 adjacent to the connection section 26 corresponds to 7°. The outer diameter K of the holding section 16 is so selected that the outer thread 16 adequately taps the wall of a borehole upon setting of a fastening element 11 for obtaining a mechanical anchoring of the fastening element 11. On the outer side of the holding section 16, there are further provided two helical grooves that form up-channels 22 for a hardenable mass.

The connection section 26 has a circular cross-section with an outer diameter F that corresponds to 0.4 times of the outer diameter K of the holding section 16.

The anchoring section 36 likewise has a circular cross-section with an outer diameter G. The outer diameter G is smaller than the outer diameter K of the holding section 16 and corresponds maximum to the nominal diameter of the borehole in which the fastening element 11 is to be set. On the circumference of the connection section 26, there is provided a profile 37 in form of a thread.

For filling in the borehole after setting of a fastening element 11, a filling bore 41 extends along the longitudinal axis 12 out of the blind bore 17 of the holding section 16 and through the holding section 16, the connection section 26, and the anchoring section 36. The filling bore 41 opens at the free end 38 of the anchoring section 36.

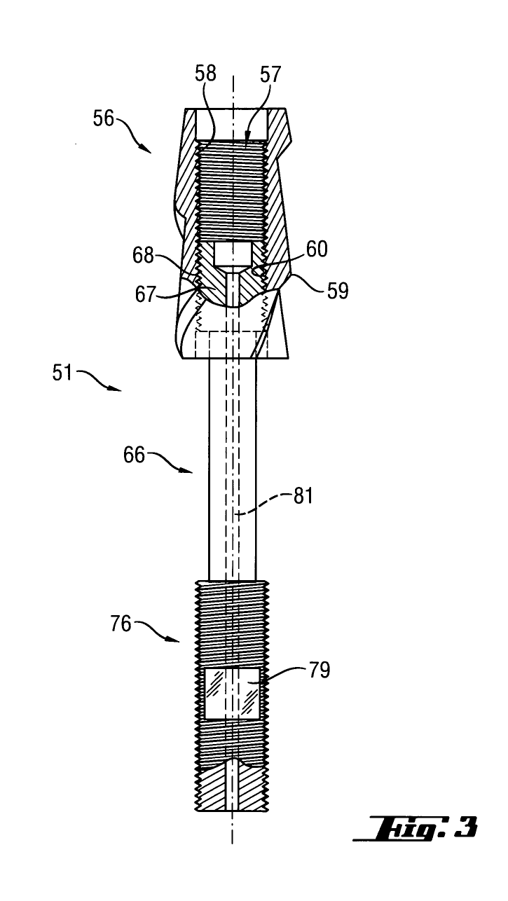

A fastening element 51 according to a second embodiment of the present invention, which is shown in FIG. 3, is formed, contrary to the fastening element 11 shown in FIGS. 1-2, of two parts. The holding section 56 is formed with a throughbore 57 that is provided, in some regions, with an inner thread that serves as load application means 58 and coupling means 60. The thread-tapping outer thread 59 is formed, broadly, as the outer thread 19 of the holding section 16 of the fastening element 11.

The connection section 66 of the fastening element 51 has, at one of its end, a section 67 having an outer thread that forms counter-coupling means 68 and is screwable into the inner thread of the holding section 56, which forms the coupling means 60. At the opposite end of the connection section 66, there is formed an anchoring section 76 having flats 79 designed for engagement with a tool to facilitate assembly and disassembly of the two-part fastening element 51.

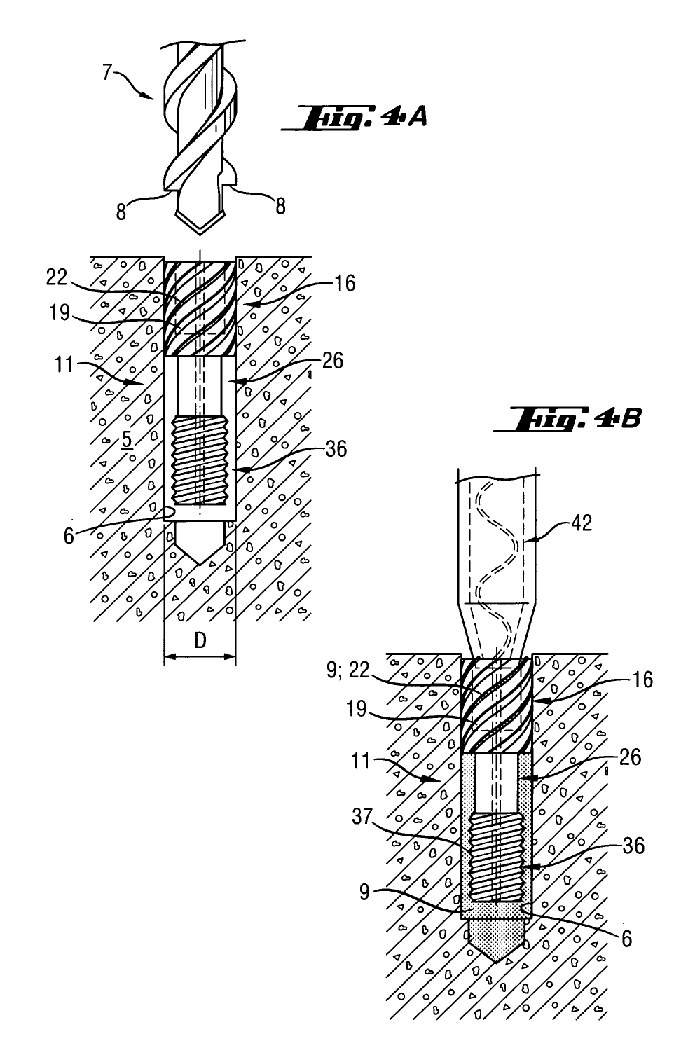

FIGS. 4A and 4B illustrate a method of setting a fastening element 11 according to the present invention. As shown in FIG. 4, a borehole 6 with a nominal diameter D is initially formed with a drill 7 in a constructional component 5. Then, a fastening element 11 is driven in the borehole 6 with a drill 7 that serves as drive-in tool. To this end, the drill 7 is provided with two, projecting radially outwardly, impact rims 8 which impact, during setting of the fastening element 11 the holding section 16, transmitting an impact energy from a power tool, not shown, to the fastening element 11. When the fastening element 11 is being driven into the borehole 6, the outer thread 19 on the holding section 16y taps the wall of the borehole 6, whereby the fastening element 11 is mechanically anchored and can be loaded right away to a level determined by the mechanical anchoring.

As shown in FIG. 4b, a hardenable mass 9 is introduced by a suitable filling device 42 through the filling bore 41 into, the borehole 6 until it raises through the up-channels 22, in the holding section 16 and is visible to the user, indicating that the borehole 6 is completely filled. After hardening of the hardenable mass 9 the fastening element 16 can be completely loaded.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A fastening element to be chemically anchored in a borehole (6), comprising a holding section (16; 56) for contacting a wall of the borehole (6) and provided with a thread-tapping outer thread (19) and with load application means (18; 58); a connection section (26; 66) adjoining the holding section (16; 56) and having a smaller radial dimensions than the holding section (16; 56); and an anchoring section (36; 76) adjoining the connection section (26; 66) and likewise having smaller radial dimensions than the holding section (16; 56).

2. A fastening element according to claim 1, wherein a lead of the thread-tapping outer thread (19) toward a longitudinal axis (12) of the fastening element (11, 51) corresponds to from 30° to 70°.

3. A fastening element according to claim 1, wherein a flank (20) of the thread-tapping outer thread (19; 59) adjacent to a free end of the holding section (16; 56) has a flank angle (A) toward a plane (E) extending perpendicular to a longitudinal axis (12) of the fastening element (11) corresponding to from 82° to 88°.

4. A fastening element according to claim 3, wherein a flank (21) of the thread-tapping outer thread (19; 59) remote from a free end of the holding section (16; 56) has a flank angle (B) toward a plane (E) extending perpendicular to a longitudinal axis (12) of the fastening element (11) corresponding to from 3° to 10°.

5. A fastening element according to claim 1, wherein the thread-tapping outer thread (19; 59) is formed as a multi-start thread.

6. A fastening element according to claim 1, wherein the holding section (16) is provided with at least one up-channel (22) for a hardenable mass (9).

7. A fastening element according to claim 1, further comprising a filling bore (41; 81) extending substantially along a longitudinal axis (12) of the fastening element (11; 51) proceeding from the holding section (16; 59) and at least into the connection section (26, 66) for filling the borehole (6) with a hardenable mass (9).

8. A fastening element according to claim 7, wherein the filling bore (41; 81) extends into the anchoring section (36; 76).

9. A fastening element according to claim 1, wherein the holding section (56) has coupling means (60), and the connection section (66) has complementary counter-coupling means (68).

10. A fastening element according to claim 9, wherein the coupling means (60) has a section with an inner thread, and the counter-coupling means (68) has a section (67) with an outer thread that cooperates with the inner thread section.

11. A method of setting a fastening element into a bore hole (6), fastening element including a holding section (16; 56) for contacting a wall of the borehole (6) and provided with a thread-tapping outer thread (19) and with load application means (18; 58); a connection section (26; 66) adjoining the holding section (16; 56) and having smaller radial dimensions than the holding section (16; 56); and an anchoring section 36; 76) adjoining the connection section 26; 66) and likewise having smaller radial dimensions than the holding section (16; 56); the method comprising the steps of:
drilling the borehole (6) in a constructional component (50;
cleaning the borehole (6);
driving the fastening element (11; 51) into the borehole (6), with the holding section (16; 56) of the fastening element (11; 51) forming a helically-shaped undercut in a borehole wall for mechanically anchoring the fastening element (11; 51) in the borehole (6); and
filling the borehole (6) with a hardenable mass (9) for chemically anchoring the fastening element (11; 51) in the borehole (6).
